(19) United States
(12) Patent Application Publication
(10) Pub. No.: US 2016/0055574 A1
(43) Pub. Date: Feb. 25, 2016

(54) Retail Store Layout Based on Online Actions

(71) Applicant: Target Brands, Inc., Minneapolis, MN (US)

(72) Inventor: Bharath Kumar Rangarajan, Edina, MN (US)

(21) Appl. No.: 14/464,236

(22) Filed: Aug. 20, 2014

(51) Int. Cl. G06Q 30/06

(52) U.S. Cl. CPC G06Q 30/0641

(57) ABSTRACT

Clusters of products are identified based on user interactions with product information stored on a computer network. A layout of a physical store is displayed such that for at least one cluster of products, the displayed layout indicates which areas of the physical store contain products in the cluster.

### BACKGROUND

A retail store's layout is an important factor in the quality of the shopping experience and the ability of the store to generate profits. A store's layout refers to the placement of display units such as shelves, gondolas and clothing racks within the store as well as the assignment of products to those display units. Often, products are grouped based on departments such as women's wear, men's wear, children's clothing, health and beauty, toys, stationery, food, hardware and seasonal products, for example.

Instead of going to a physical store, customers can also shop online using an Internet website that displays products for sale. On many websites, customers can set one or more criteria for the products they wish to view such as products in a specific department or products that match a specific search term. Upon receiving these criteria, a web server retrieves or generates a webpage that contains products that meet the criteria. The user can view the products on the webpage and/or request additional webpages that show products that meet the criteria. When a user finds a product that they wish to purchase, they can add the product to their electronic shopping cart and at a desired time proceed to check-out where they can purchase the products in their electronic shopping cart.

The discussion above is merely provided for general background information and is not intended to be used as an aid in determining the scope of the claimed subject matter. The claimed subject matter is not limited to implementations that solve any or all disadvantages noted in the background.

### SUMMARY

Clusters of products are identified based on user interactions with product information stored on a computer network. A layout of a physical store is displayed such that for at least one cluster of products, the displayed layout indicates which areas of the physical store contain products in the cluster.

In a further embodiment, the clusters of products are clusters of departments and for at least one cluster of departments, the displayed layout indicates the areas of the physical store that contain departments in the cluster of departments.

In a further embodiment, affinity groups for products are formed based on online behavior. Attributes of the products are retrieved and are displayed as part of showing the affinity groups. A common attribute of products within an affinity group is determined and a layout of a physical store is altered based on the common attribute.

In a further embodiment, a system is provided that includes computer instructions that display products for sale and that store records of products displayed without necessarily being purchased during each of a plurality of online sessions. A clustering application uses the records to form clusters of products. A visualization application displays the physical location of the clusters on an existing store layout for a physical store.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a system used to produce a store layout for a physical store based on actions taken online.

FIG. 2 is a flow diagram of a method for modifying a physical store layout based on actions taken online.

FIG. 3 is an example of a user interface displaying an online shopping page.

FIG. 4 is an example of a user interface displaying a second embodiment of an online shopping page.

FIG. 5 is a flow diagram of a method of altering a layout of a physical store based on actions taken online in accordance with one embodiment.

FIG. 6 is a user interface providing a visualization of product affinities using the method of FIG. 5.

FIG. 7 is a second embodiment of a user interface providing a visualization of product affinities using the method of FIG. 5.

FIG. 8 is a third embodiment of a user interface providing a visualization of product affinities using the method of FIG. 5.

FIG. 9 is a fourth embodiment of a user interface providing a visualization of product affinities using the method of FIG. 5.

FIG. 10 is a fifth embodiment of a user interface providing a visualization of product affinities using the method of FIG. 5.

FIG. 11 is a flow diagram of a method of modifying a physical store layout based on actions taken online in accordance with a second embodiment.

FIG. 12 is a user interface providing a visualization of product affinities using the method of FIG. 11.

FIG. 13 is a second embodiment of a user interface providing a visualization of product affinities using the method of FIG. 11.

FIG. 14 is a flow diagram for altering a physical store layout based on actions taken online in accordance with a third embodiment.

FIG. 15 is a user interface showing department clusters produced using the flow diagram of FIG. 14.

FIG. 16 is a user interface showing department clusters on a modified store layout.

FIG. 17 is a user interface showing product clusters within a department layout using the flow diagram of FIG. 14.

FIG. 18 is a user interface showing product affinities within a modified department layout.

FIG. 19 is a user interface showing department clusters in accordance with a second embodiment.

FIG. 20 is a user interface showing department clusters in accordance with a third embodiment.

FIG. 21 provides a block diagram of a computing device that may be used as a client, server or data warehouse server.

### DETAILED DESCRIPTION

Embodiments provided below use actions taken online to modify or alter the layout of a physical store. In particular, co-occurrence data is collected by creating a co-occurrence count for pairs of products that are displayed online. Each time a user views two products during a same online session, the co-occurrence count for those two products is increased by one. Using this co-occurrence data, affinities between products are determined and can be used to identify clusters of products that customers are likely to want to view together. The clusters and/or the affinities between products are displayed in a user interface, which is used to modify the layout of a physical store. For example, if the user interface shows that products in a same cluster are dispersed in an existing store layout, the store layout is modified to bring the products closer together to make the shopping experience more efficient for the consumer.

In some embodiments, products are grouped based on common attributes and the co-occurrence data is used to cluster the product groups. In still further embodiments, the products are grouped by department and the co-occurrence data is used to create clusters of departments. The user interface then provides a visualization of the clusters and/or affinities between the product groups. The user interface is then used to modify the layout of the product groups in the physical store.

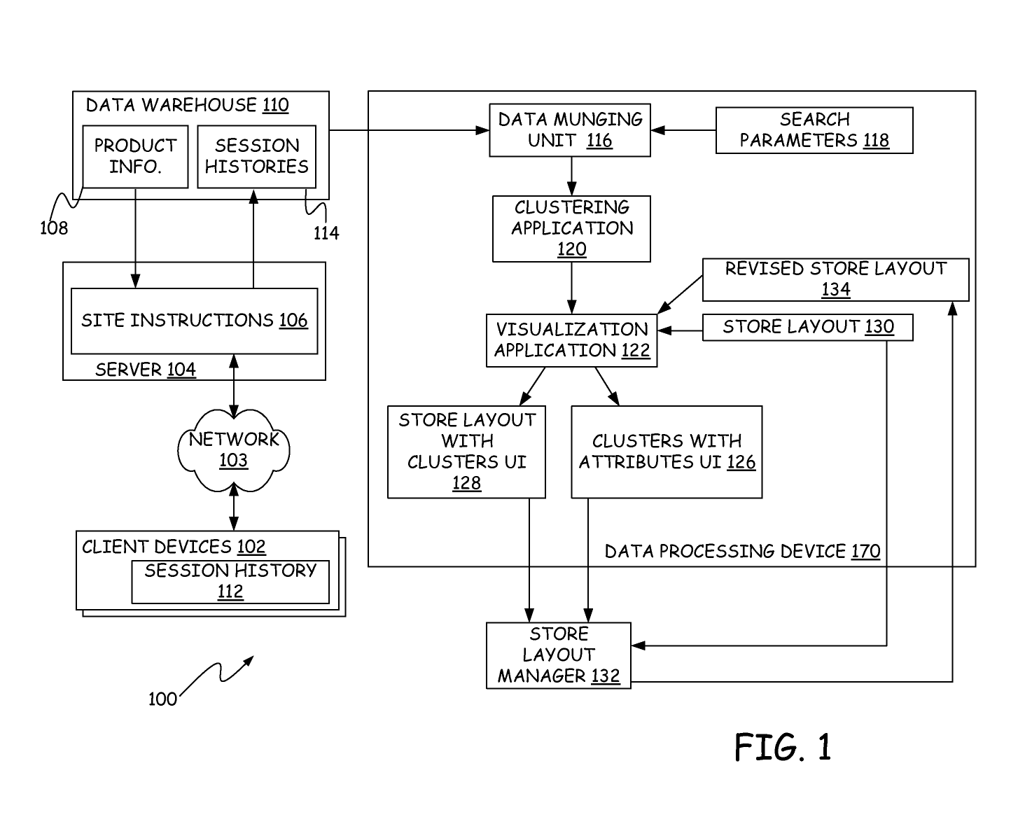

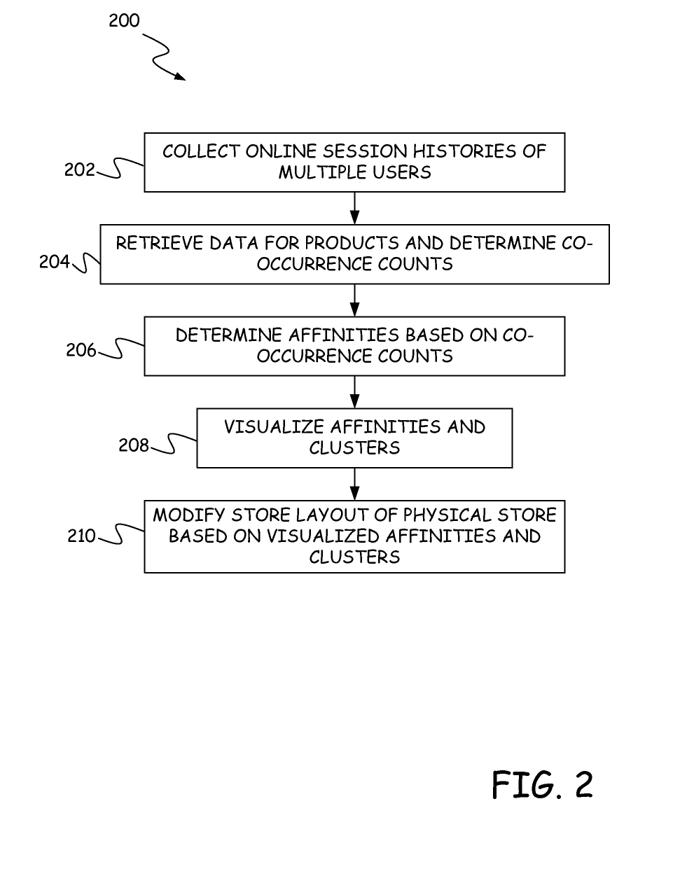

FIG. 1 provides a block diagram of a system 100 used to produce a layout for a physical store based on actions taken online and FIG. 2 provides a flow diagram 200 for modifying a layout of a physical store based on actions taken online. As shown in FIG. 1, a plurality of client devices 102 communicates through a network 103 to a server 104. Server 104 hosts site instructions 106 that process requests from client device 102 and generate responses that are returned to the client devices. The responses, which can take the form of webpages, generally cause a user interface to be displayed on the requesting client device 102. The user interface can include product information 108 that is retrieved from a data warehouse 110.

Site instructions 106 utilize the concept of a session, in which requests and responses between a particular client and site instructions 106 over a relatively short time span, generally less than an hour, are considered to be linked together. Site instructions 106 include instructions for starting a session with one of the client devices 102. Once a session is initiated, client devices 102 records information about actions taken by the user during the session in a session history 112. These actions can include user interfaces/pages viewed by a user, products viewed by the user, products placed in an electronic shopping cart by the user, and products purchased by the user, for example. Session histories 112 may take the form of one or more “cookies” or temporary files on client device 102. Site instructions 106 will end a session after a period of time passes and no further requests are received from the client.

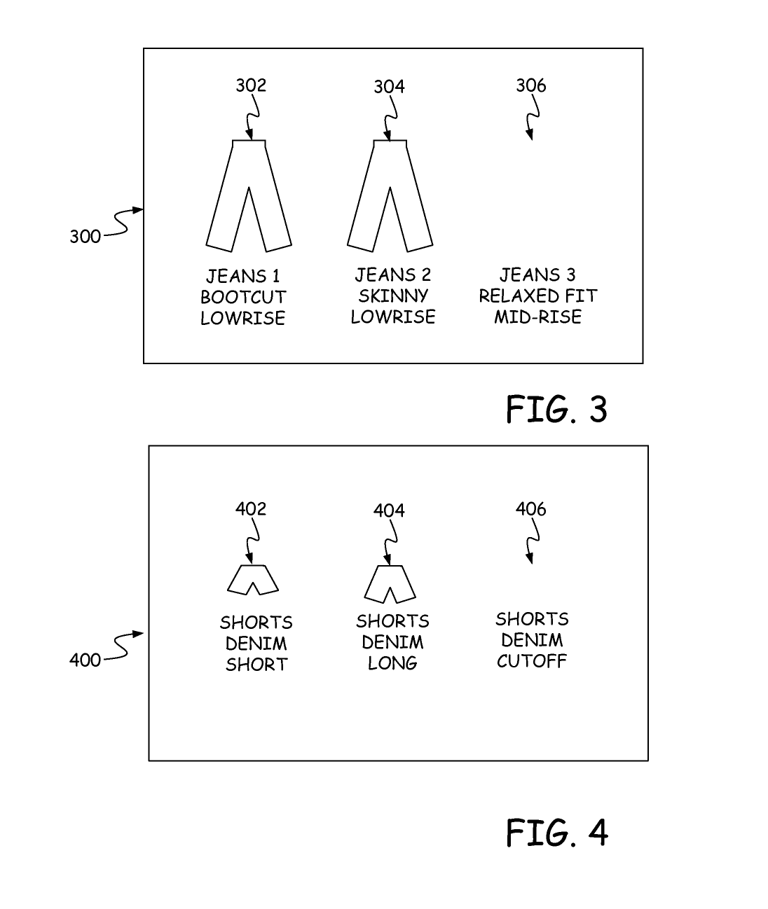

FIG. 3 provides an example of a webpage user interface generated by site instructions 106 that displays some of product information 108. In accordance with one embodiment, when user interface 300 of FIG. 3 is displayed, the user is considered to have viewed products 302, 304 and 306. Note that for products 302 and 304, an image of the product and a description of the product are provided, but for product 306, only a description of the product is provided. Thus, in accordance with one embodiment, a user is considered to have viewed a product if they have viewed either a description or an image of the product or both. In such embodiments, session histories 112 would be updated to indicate that products 302, 304 and 306 were viewed by the user during a same session. In other embodiments, the user must select a product from user interface 300 to request a details page for the product before the user will be considered to have viewed the product. The details page may include an image of the product, a description of the product without an image or an image and a description of the product. Regardless of the information provided on the details page, the user will be considered to have viewed the product if the user has requested a details page for the product in such embodiments.

FIG. 4 provides a user interface 400 showing products displayed by a second webpage generated by site instructions 106. As shown in user interface 400, products 402, 404 and 406 are provided with products 402 and 404 having images and descriptions of the products and product 406 having only a description of the product and not an image. In accordance with one embodiment, when user interface 400 is served to the client device, the user is considered to have viewed each of the products on the webpage and the session history 112 would be updated to indicate that products 402, 404 and 406 were all viewed during a same session. In other embodiments, the user must select a product from user interface 400 to request a details page for the product before the user will be considered to have viewed the product. The details page may include an image of the product, a description of the product without an image or an image and a description of the product. Regardless of the information provided on the details page, the user will be considered to have viewed the product if the user has requested a details page for the product in such embodiments.

In embodiments in which a user is considered to have viewed a product if a description of the product, image of the product or both appear on a webpage served to the client device, session history 112 would indicate that products 302, 304, 306, 402, 404 and 406 were all viewed during a same session if the user had viewed both user interface 300 and user interface 400 during a same session.

In step 202 of FIG. 2, site instructions 106 request that client devices 102 provide their session histories 112 so that the session histories can be accumulated and stored as session histories 114 in data warehouse 110. This request can be made to different client devices 102 at different times. The session histories 114 are stored such that the actions taken during any one session can be determined.

At step 204, a data munging unit 116 on a data processing device 170 uses search parameters 118 to retrieve session history data for products. Search parameters 118 can include one or more attributes, such as size, color or department, for example, that define groups of products. Search parameters 118 can also include filter parameters that limit the retrieved session history data to session history data relating to particular products. For example, search parameters 118 can include a filter parameter that limits the retrieved session history data to session history data involving products in a single department. Data munging unit 116 also determines co-occurrence counts for individual products or for product groups if such groups are defined by search parameters 118.

In accordance with one embodiment, a co-occurrence count for a pair of products indicates the number of sessions during which the two products were viewed and a co-occurrence count for a pair of product groups indicates the number of sessions during which at least one product from each of the two product groups was viewed regardless of whether either product was purchased. In other embodiments, the co-occurrence counts are based on the products that were placed in an electronic shopping cart instead of being based on the products that were viewed. In still further embodiments, the co-occurrence counts are based on products that were purchased instead of being based on products that were viewed or products that were placed in the electronic shopping cart. However, since customers tend to view many more products than they put in the electronic shopping cart or purchase, it is beneficial to use the products that were viewed for the co-occurrence count since it provides much more data for clustering products and product groups.

At step 206, a clustering application 120 on data processing device 170 determines affinities and forms affinity groups or clusters based on the co-occurrence counts. The affinities and the clusters can be between product groups or between products and any clustering algorithm that utilizes co-occurrence data can be used to determine the affinities and the clusters. In some embodiments, multi-level clustering is used such that a higher level cluster will include a plurality of lower level clusters.

At step 208, a visualization application 122 on data processing device 170 visualizes the affinities and clusters determined by clustering application 120. In accordance with one embodiment, visualizing the affinities and clusters comprises displaying Clusters-with-Attributes user interface 126 that shows clusters of products or product groups together with certain attributes of the products and product groups. Examples of such user interfaces are discussed further below. In other embodiments, a Store Layout-with-Clusters user interface 128 is used to visualize the affinities and the clusters. Store Layout-with-Clusters user interface 128 shows a store layout 130 or a portion of a store layout together with indications of which areas of the store contain products assigned to particular clusters. Examples of such user interfaces are discussed further below.

At step 210, a store layout manager 132 uses user interface 126 and/or user interface 128 to modify store layout 130 to form a revised or modified store layout 134.

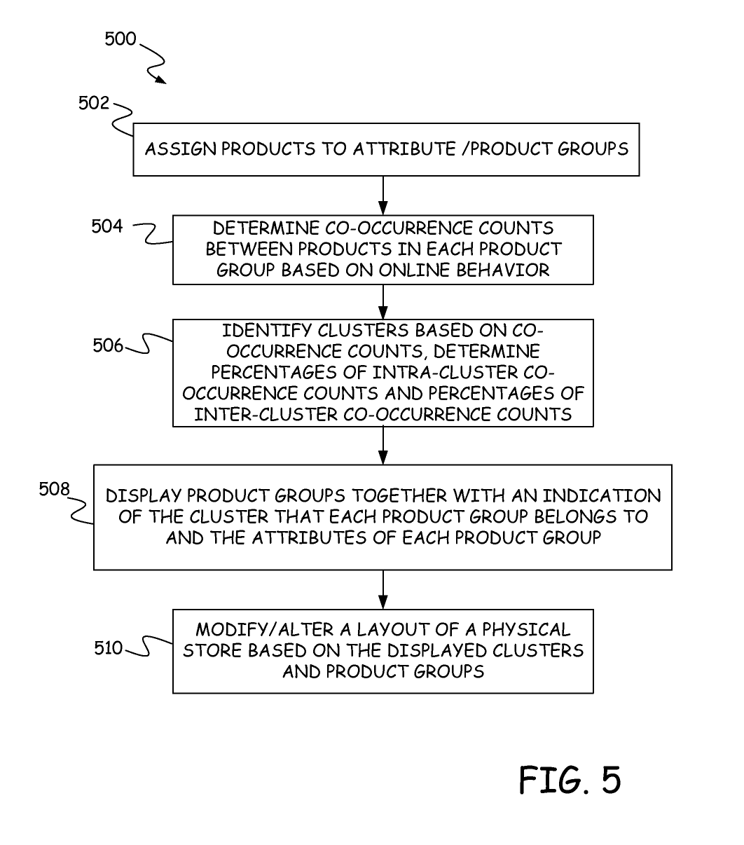

FIG. 5 provides a more detailed flow diagram 500 of one embodiment for modifying a layout of a physical store based on actions taken online.

In step 502, products are assigned to product groups, also referred to as attribute groups, based on one or more attribute keys, such as waist, cut, color, size, brand, and type, for example. Those skilled in the art will recognize that any desired attributes can be used. The assignment of products to product groups can be performed by data munging unit 116 using attributes provided in search parameters 118. In particular, data munging unit 116 can retrieve the attributes of products in product information 108 and group the products based on the retrieved attributes.

At step 504, data munging unit 116 determines co-occurrence counts for each pair of product groups using session histories 114. A co-occurrence count for a pair of product groups is the number of sessions in which at least one product from each product group in the pair was viewed.

At step 506, clustering application 120 identifies affinity groups or clusters based on the co-occurrence counts determined by data munging unit 116. In accordance with one embodiment, during such clustering, clustering application 120 uses a threshold affinity to determine when product groups should be placed in a same cluster. In addition, clustering application 120 determines the relative percentages of co-occurrence counts within the clusters (intra-cluster co-occurrence counts) and across clusters (inter-cluster co-occurrence counts). A percentage of co-occurrence counts that occur within a cluster can be determined by dividing the number of co-occurrences where both the products are in the same cluster by the total number of co-occurrences across all clusters. The percentage of co-occurrence counts across any two clusters can be determined by summing the co-occurrence counts for product group pairs that include a product group from each cluster and dividing the sum by the total number of co-occurrences.

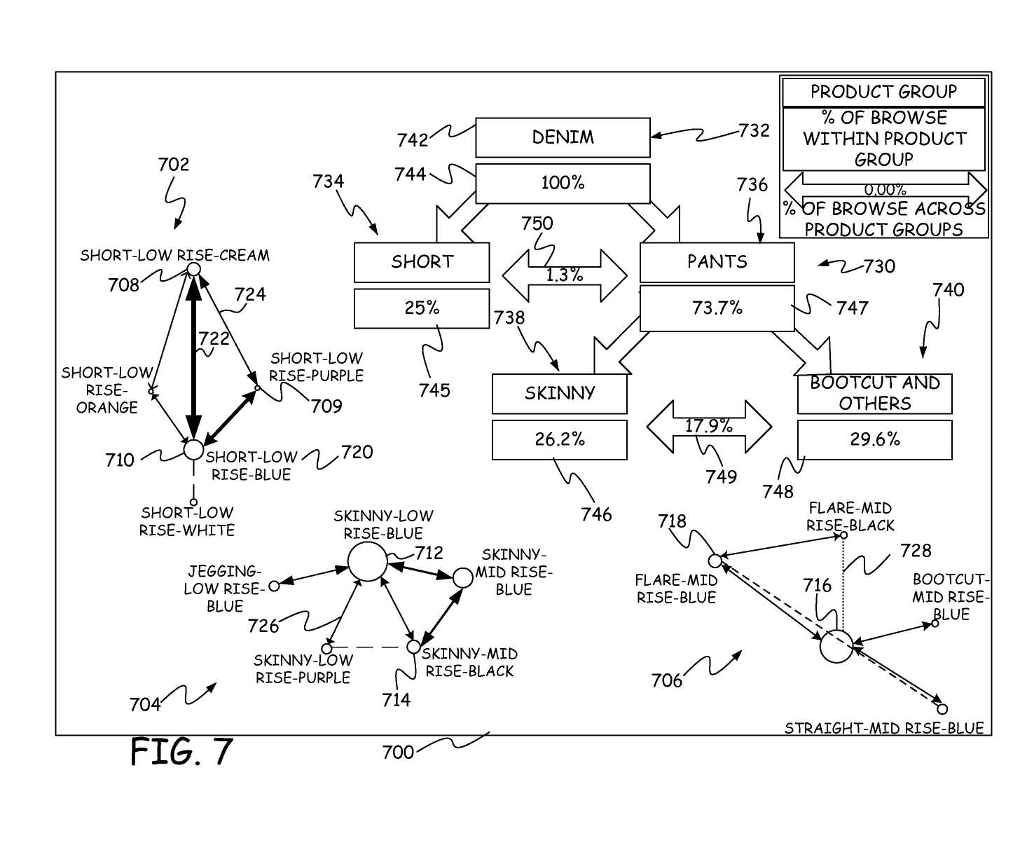

At step 508, visualization application 122 displays Clusters-with-Attributes user interface 126, which depicts the product groups together with an indication of the clusters that each product group belongs to and the attribute values of each product group. Examples of user interface 126 are shown in FIGS. 7-10 discussed further below.

At step 510, store layout manager 132 modifies/alters a layout of a physical store based on the displayed clusters and product groups. In accordance with one embodiment, modifying the layout involves grouping products that are found within a same cluster closer together in the store. By grouping such products closer together in the store, it becomes more convenient for consumers to find products that they tend to view together online. Thus, the online behavior of users indicates that certain products tend to be viewed together during shopping and as such, it is helpful to the shopper if such products are placed near each other in a physical store. In other embodiments, modifying or altering the layout of a physical store involves creating a path through the store by placing the products that online customers tend to view together along the path. It is then possible to place additional products along the path so that the customer will see the additional products and thereby increase the likelihood that the customer will purchase the additional products.

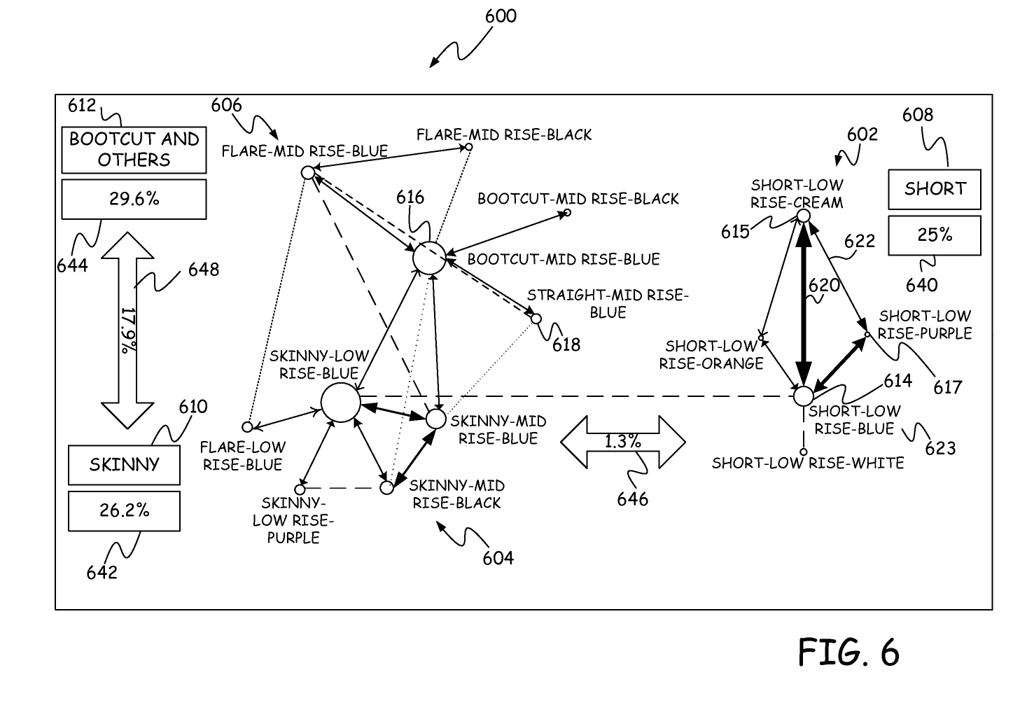

FIG. 6 provides one example of user interface 126 displayed by visualization application 122 in step 508. In user interface 600 of FIG. 6, three clusters 602, 604 and 606 are provided. Cluster 602 has a label 608, cluster 604 has a label 610 and cluster 606 has a label 612. Labels 608, 610 and 612 are selected based on a common attribute among the product groups in each cluster. For example, in cluster 602, each of the product groups has a “short” attribute and as such, label 608 for cluster 602 is “SHORT.”

Each product group is represented by a circle such as circles 614, 615, 616, 617 and 618, for example. For clarity, not all of the circles representing a product group have been numbered. The size of each circle represents the number of products assigned to each attribute/product group by data munging unit 116. The distance between circles represents the affinity between product groups with shorter distances indicating a greater affinity between the product groups. Connecting lines and arrows between the circles represent co-occurrences of products from the two product groups connected by the line or arrow. The width of the line or arrow shows the relative number of co-occurrence counts between the product groups with thicker lines indicating more co-occurrences. For example, line 620 which connects product group 614 to product group 615 is thicker than line 622 which connects product group 617 with product group 615. As such, lines 620 and 622 together indicate that there are more co-occurrences between product groups 614 and 615 than between product groups 617 and 615.

Each product group is also represented by an attribute label such as attribute label 623 for product group 614. The attribute labels indicate the attribute values that are common to all of the products in the product group. For example, in product group 614, all the products have attribute values of “short”, “low rise” and “blue”. Each product group has a different attribute label since each product group represents a different combination of attribute values for three attributes: cut, waist, and color, set in search parameters 118 and used by data munging unit 116 to form the product groups.

User interface 600 also includes intra-cluster co-occurrence percentages 640, 642 and 644 that each indicates the percentage of co-occurrences that are between product groups within a cluster. For example, intra-cluster co-occurrence percentage 640 indicates that 25% of all co-occurrences involve the co-occurrence of two products in cluster 602. User interface 600 also includes inter-cluster co-occurrence percentages 646 and 648 that each indicate co-occurrences between clusters. For example, inter-cluster co-occurrence percentage 646 indicates that 1.3% of all co-occurrences involve a product from cluster 602 and a product from either cluster 604 or cluster 606.

FIG. 7 provides user interface 700, which is a second embodiment of user interface 126 of FIG. 1 produced through the process of FIG. 5. In user interface 700, clusters 702, 704 and 706 are shown in isolation. Within each cluster, product groups are shown by circles such as circles 708, 709, 710, 712, 714, 716 and 718. The size of each circle indicates the number products that have been assigned to the product group. In addition, each product group is labeled with an attribute label, such as attribute label 720, which indicates attribute values common to all of the products assigned to the product group. In user interface 700, there are three attributes that are used to group the products and as such, each attribute label includes three attribute values. For example, attribute label 720 includes values of “short”, “low rise” and “blue”.

Within each cluster, product groups are connected by lines such as lines 722, 724, 726, and 728. The thickness of the lines indicates the number of co-occurrences between the product groups with thicker lines indicating more co-occurrences. For example, line 722 between product group 710 and product group 708 is thicker than line 724 between product group 709 and product group 708. As such, lines 722 and 724 indicate that there are more co-occurrences between group 710 and group 708 than between group 709 and group 708. The spacing between circles within each cluster indicates the relative affinity between the product groups in the cluster.

In user interface 700, there are no direct connection lines shown between product groups of different clusters. Instead, a consumer browse tree 730 is provided. Consumer browse tree 730 shows multiple levels of clusters with a top level cluster 732, mid-level clusters 734 and 736 and low level clusters 738 and 740. Mid-level clusters 734 and 736 are part of high level cluster 732 and low level clusters 738 and 740 are part of mid-level cluster 736. Each cluster includes a cluster label such as cluster label 742 for cluster 732. Each cluster label includes an attribute value that is common to all of the product groups within the cluster. For example, all of the product groups within cluster 732 have an attribute value of denim.

User interface 700 also includes intra-cluster percentages 744, 745, 746, 747 and 748 that each indicates a percentage of co-occurrences that are between product groups within a cluster. For example, intra-cluster percentage 744 indicates that all of the co-occurrences are between product groups within cluster 732 while intra-cluster percentage 746 indicates that 26.2% of all co-occurrences are between product groups within cluster 738.

User interface 700 also includes inter-cluster percentages 749 and 750. Each inter-cluster percentage is shown within an arrow that is connected between two clusters where the inter-cluster percentage indicates a percentage of co-occurrences that involve a product group from each of the two clusters connected by the arrow. For example, inter-cluster percentage 750 indicates that 1.3% of co-occurrences are between cluster 734 and cluster 736.

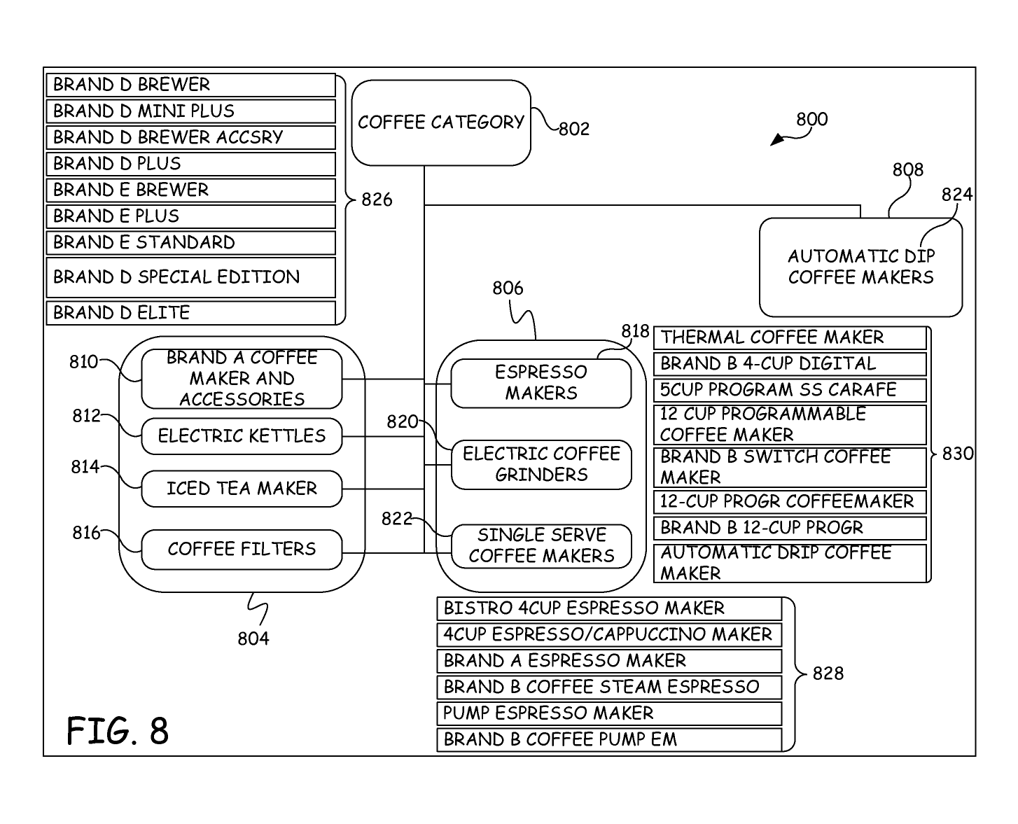

FIG. 8 provides a user interface 800, which is a third embodiment of user interface 126 produced through the process of FIG. 5. User interface 800 includes two levels of clusters with a top level cluster 802 and three lower level clusters 804, 806 and 808. Cluster 804 includes product groups 810, 812, 814 and 816. Cluster 806 includes product groups 818, 820 and 822. Cluster 808 includes a single product group 824. Clusters 804, 806 and 808 also include a respective product list 826, 828 and 830 that indicate the products in each cluster. Thus, user interface 800 conveys which products users tend to view together when looking at products in coffee cluster 802.

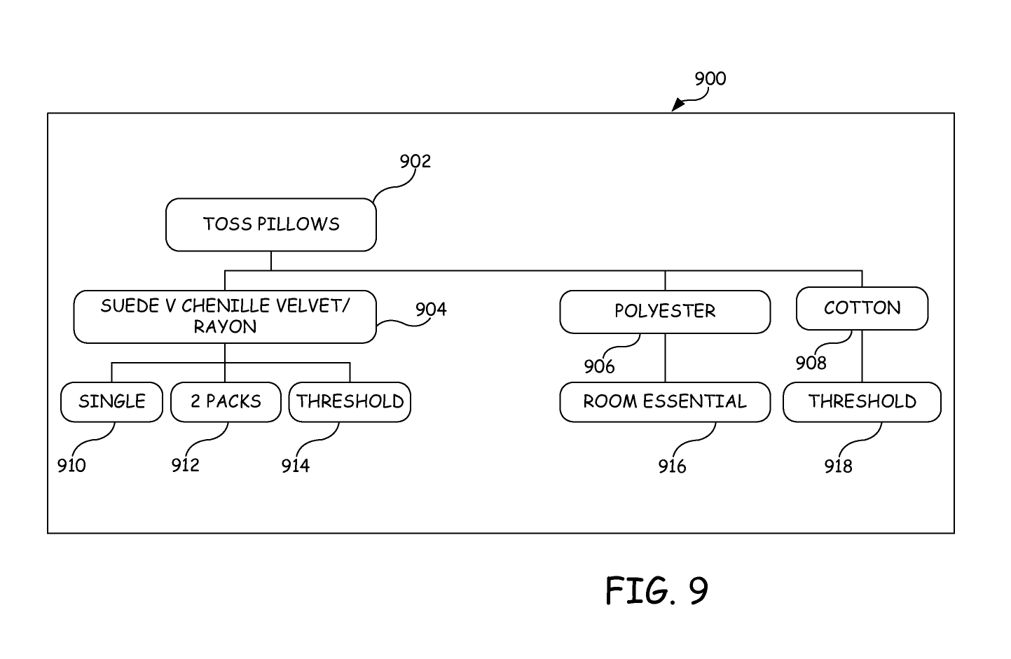

FIG. 9 provides a user interface 900, which is another embodiment of user interface 126. User interface 900 includes two levels of clusters including a top level cluster 902 and three low level clusters 904, 906 and 908. Each cluster has a label indicating an attribute common to products within the cluster. User interface 900 also includes product groups 910, 912, 914, 916 and 918 with product groups 910, 912 and 914 shown to be part of cluster 904, product group 916 shown to be part of cluster 906 and product group 918 shown to be part of cluster 908. Clusters 904, 906 and 908 are each part of cluster 902. Each of product groups 910, 912, 914, 916 and 918 are displayed with an attribute title indicating an attribute common to all products in the product group such as “single” for product group 910 and “room essential” for product group 916.

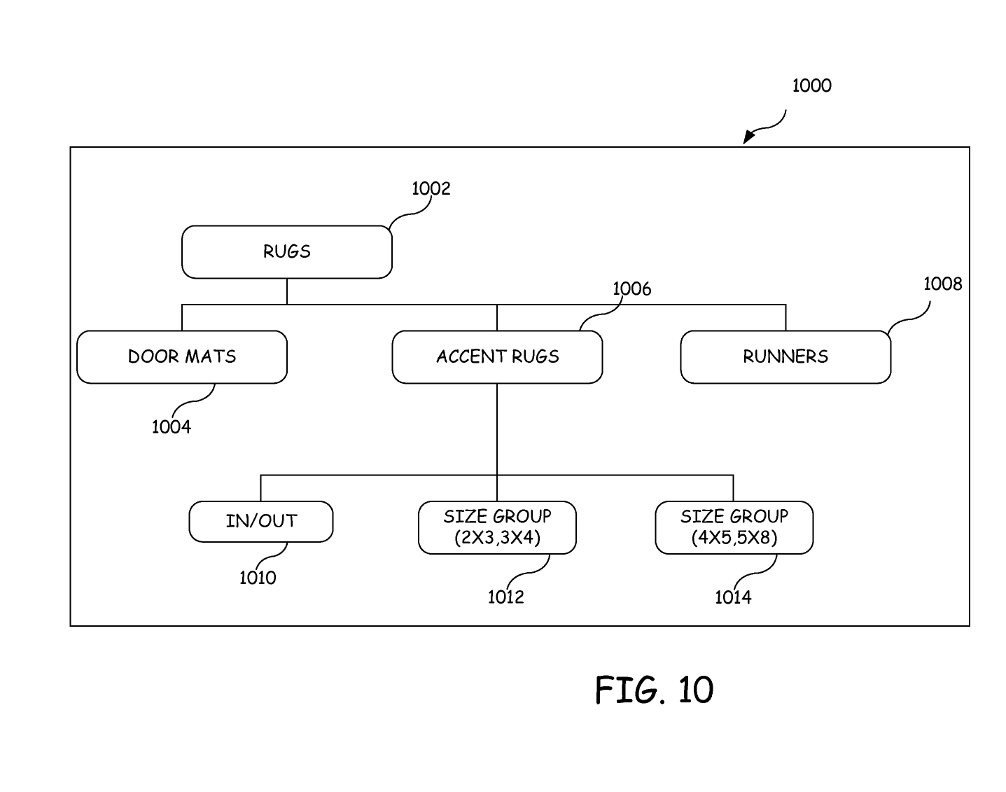

FIG. 10 provides a user interface 1000, which is another embodiment of user interface 126 of FIG. 1. In user interface 1000, two cluster levels are provided with a top cluster 1002 and three lower clusters 1004, 1006 and 1008 that are each part of cluster 1002. Each cluster includes a title that describes a common attribute of the products in the cluster such as “rugs” for cluster 1002 and “door mats”, “accent rugs” and “runners” for clusters 1004, 1006 and 1008.

Cluster 1006 is shown to include product groups 1010, 1012 and 1014, which each include a respective title that describes a common attribute of the products in the product group. For example, product group 1014 includes products that are size 4×5 or 5×8.

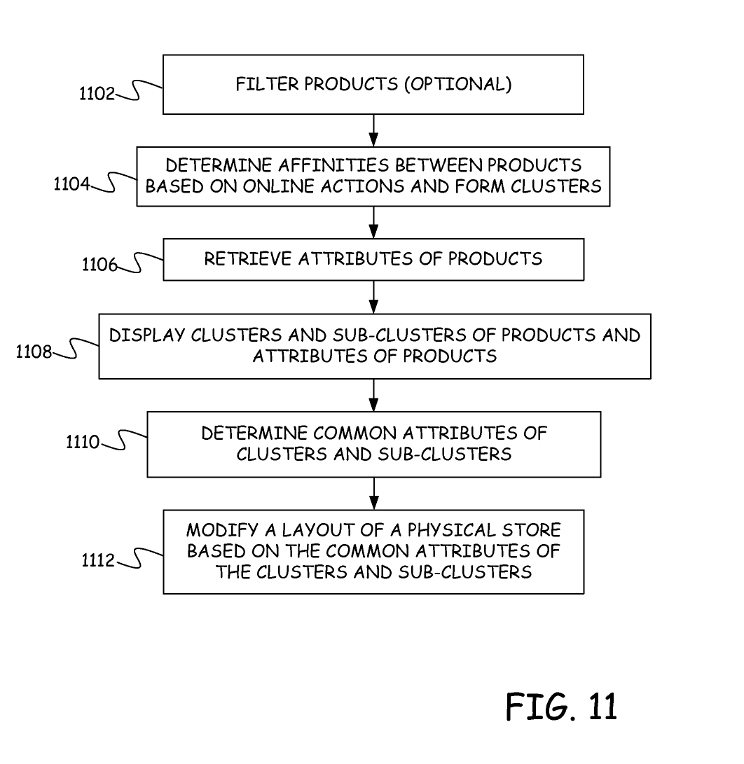

FIG. 11 provides a flow diagram 1100 of a second method for modifying layouts of physical stores based on actions taken online. At step 1102, search parameters 118 are optionally used by data munging unit 116 to filter products by department or category so that only session data for products from particular departments or categories is retrieved. At step 1104, the affinities between products are determined based on online actions. In one embodiment, the affinities are based on co-occurrence counts of product pairs. The co-occurrence counts for each pair of products represents the number of sessions in which both products were viewed by a user. These co-occurrence counts are determined by data munging unit 116 and are used by clustering application 120 to form clusters, also referred to as affinity groups, using one or more clustering algorithms.

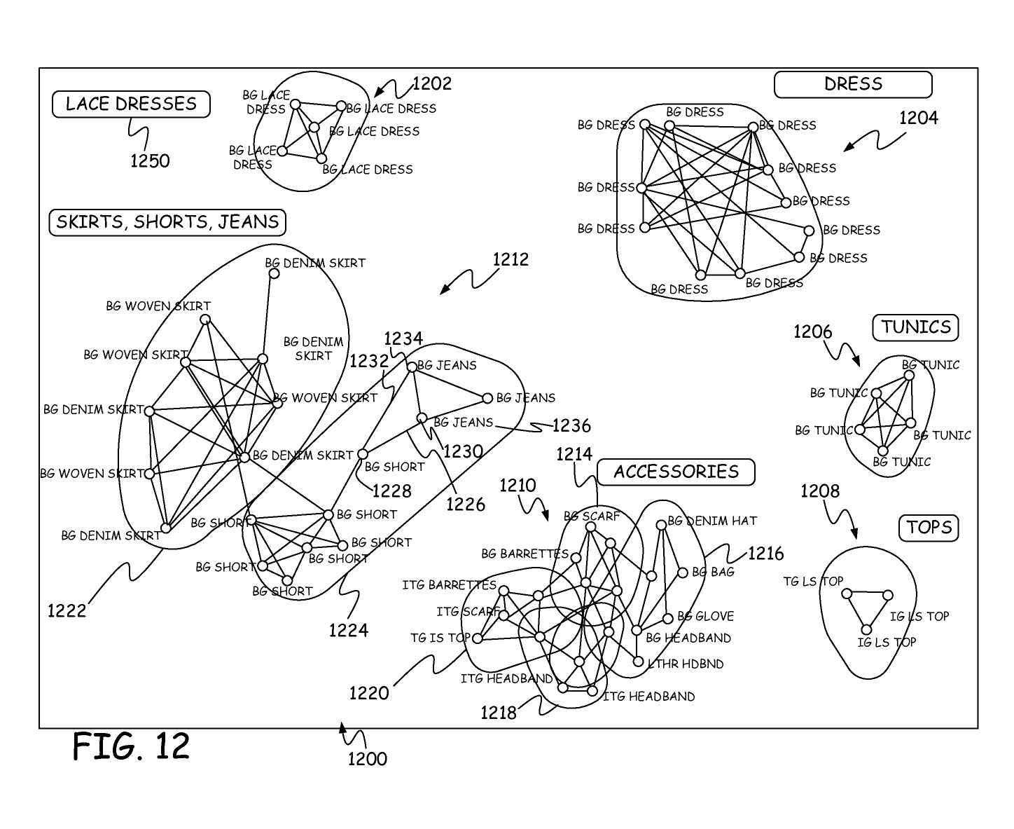

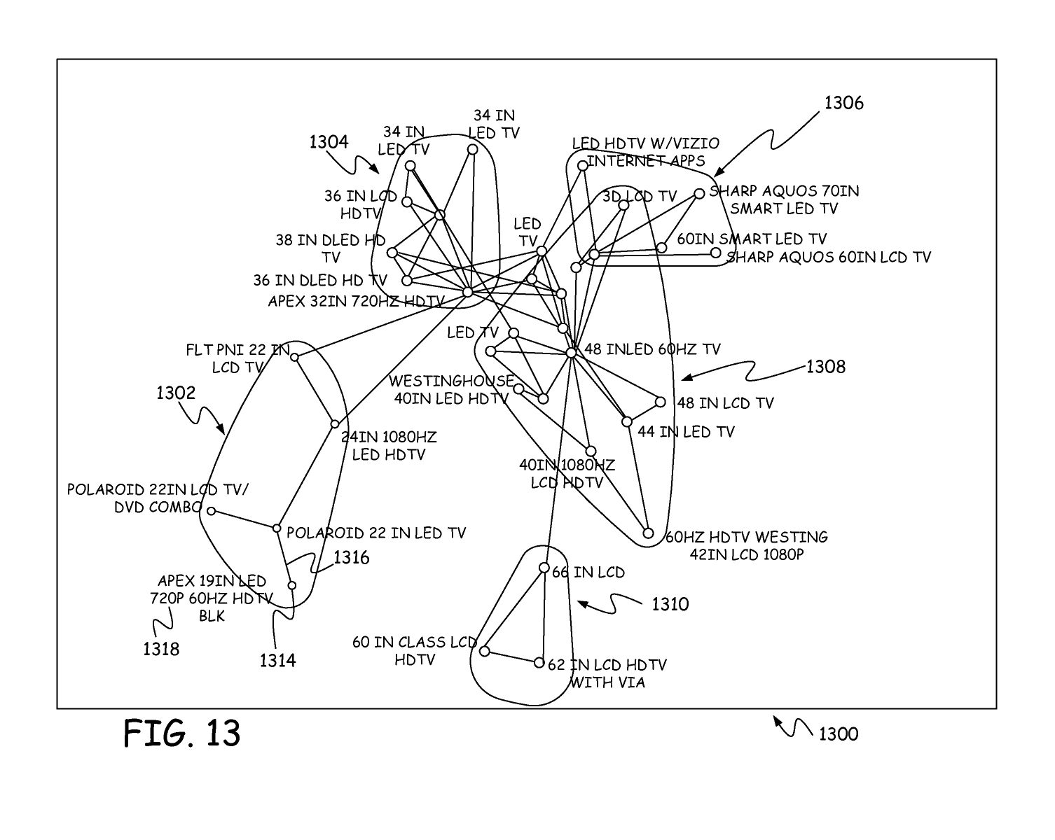

At step 1106, which may be performed by data munging unit 116 at the same time as step 1104, attributes of the products are retrieved from product information 108 in data warehouse 110. At step 1108, clusters of products and attributes are displayed on user interface 126 by visualization application 122. In user interface 126, clusters and sub-clusters of products, also referred to as affinity groups and second affinity groups, are displayed showing the affinity between products along with at least some of the attributes of those products. Examples of user interface 126 produced at step 1108 are discussed below in connection with FIGS. 12 and 13. At step 1110, common attributes of the clusters and sub-clusters are identified based on the content of user interface 126. At step 1112, the layout of a physical store is modified based on the common attributes of the clusters and sub-clusters. In particular, in accordance with one embodiment, products that share common attributes of a cluster are placed closer together in a modified layout of the physical store. In accordance with a further embodiment, products that share a same common attribute of a sub-cluster are placed together within a same area of a modified layout of the physical store. Such layouts make it easier for a customer at a physical store to find products that online customers have viewed together online.

FIG. 12 provides an example of a user interface 1200 that is displayed at step 1108 of FIG. 11. User interface 1200 includes clusters or affinity groups 1202, 1204, 1206, 1208, 1210 and 1212. Cluster 1208 includes sub-clusters or second affinity groups 1214, 1216, 1218 and 1220; cluster 1212 includes sub-clusters or second affinity groups 1222 and 1224. In user interface 1200, each product is represented by a circle and is connected to the circle of another product if the two products co-occurred during an online session. For example, in sub-cluster 1224, line 1226 indicates that products 1228 and 1230 co-occurred during at least one session and line 1232 indicates that products 1228 and 1234 co-occurred during at least one session.

Each product also includes an attribute list containing one or more attribute values. For example, product 1230 includes an attribute list 1236 that includes the phrase “BG JEANS”. Each cluster is also described by a cluster title, such as cluster title 1250 for cluster 1202. Each cluster title contains one or more attributes that are common to the products in the cluster. For example, cluster title 1250 of cluster 1202 is “lace dresses” and all of the products in cluster 1202 have attributes of “lace” and “dress.”

A layout of a physical store would be modified using user interface 1200 by providing separate sections for each cluster such as one section for lace dresses, one section for dress, one section for tunics, one section for tops, one section for accessories and one section for skirts, shorts and jeans. In addition, the sub-clusters 1214, 1216, 1218 and 1220 would be positioned near each other within the section set aside for the accessories cluster.

User interface 1200 indicates that brand does not appear to be a distinguishing factor in establishing clusters or sub-clusters. As such, the brands may be mixed within the physical store layout.

FIG. 13 provides a user interface 1300, which is an alternative embodiment of a user interface 126 displayed in step 1108 of FIG. 11. User interface 1300 includes clusters 1302, 1304, 1306, 1308, and 1310. In user interface 1300, each product is shown as a circle, such as circle 1314 and the products are connected by lines, such as lines 1316, with the length of the line being inverse to the affinity between the products on either end of the line. Thus, the longer the line between products, the less the affinity between the products during an online shopping session. Each product also includes an attribute list that indicates various attributes of the product, such as attribute list 1318 for product 1314.

Based on the attribute list, it can be seen that the clusters are based on screen size such that screens over 50 inches tend to cluster together, screens between 40 and 50 inches are clustered together, screens between 30 and 40 inches are clustered together and screens less than 30 inches are clustered together. In addition, within a size cluster, products appear to be grouped based on brand. Thus, televisions of the same brand within a size range tend to be viewed together. Lastly, Smart televisions tend to form their own cluster.

Using user interface 1300, the physical store would be modified by grouping all of the televisions by size and then within those size groupings, grouping the televisions by brand. This will make it more efficient for customers at a physical store to view products that tend to be viewed together online. For example, since customers tend to view televisions of similar sizes during the same online session, grouping televisions of similar sizes together in the physical store will allow customers in the physical store to see the televisions of similar sizes more easily.

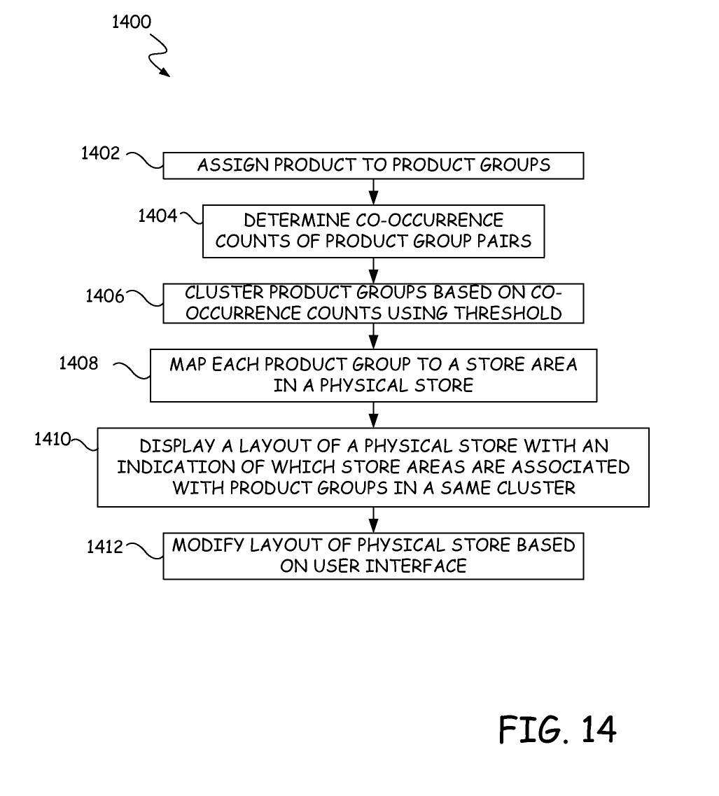

FIG. 14 provides a flow diagram 1400 of an alternative method of using online actions or behavior to alter a layout of a physical store.

At step 1402, products are assigned to product groups. In accordance with one embodiment, this is performed by data munging unit 116 using search parameters 118. During the retrieval of product information 108, data munging unit 116 places the products in the appropriate product groups. At step 1404, data munging unit 116 determines co-occurrence counts of product group pairs where each co-occurrence count is the number of online sessions where online users viewed at least one product from both product groups in the pair. At step 1406, clustering application 120 uses the co-occurrence counts to cluster the product groups using a threshold affinity such that product groups will not be placed in a same cluster unless their co-occurrence counts exceed an expected number of co-occurrence counts between product groups. Because the co-occurrence counts are based on user interactions with product information stored on a computer network, step 1406 involves identifying clusters of products based on user interactions with product information stored on a computer network. At step 1408, visualization application 122 maps each product group to a store area in a physical store, using an existing store layout 130. For example, if the product groups are departments, visualization application 122 maps each department to a store area on store layout 130. At step 1410, visualization application 122 displays a layout of a physical store with an indication of which store areas contain products from a same cluster. This is shown as Store Layout-with-Clusters user interface 128 in FIG. 1. In accordance with one embodiment, displaying a layout of a physical store with an indication of which store areas contain products from a same cluster involves shading store areas such that every store area that contains products in a cluster is the same color on user interface 128. At step 1412, a store layout manager 132 modifies the layout of a physical store based on user interface 128. The result is a revised or modified store layout 134. In accordance with one embodiment, revised store layout 134 is provided to visualization application 122 to generate a new user interface 128 that shows the store areas in revised store layout 134 that contain products from a same cluster.

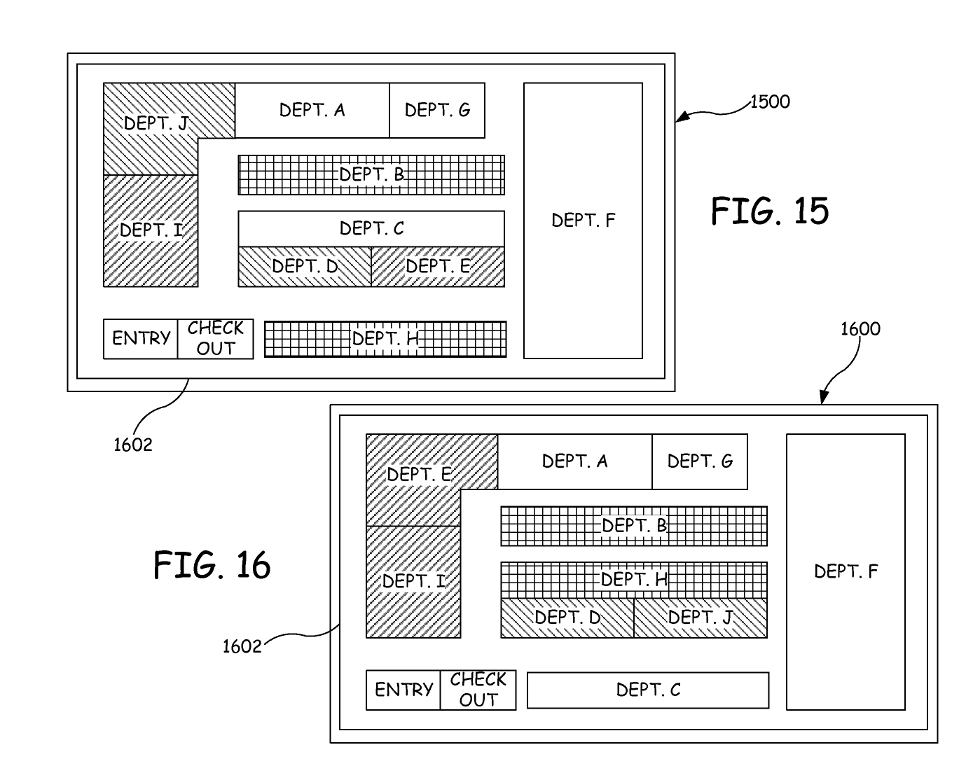

FIG. 15 provides an example user interface 1500, which is one embodiment of a Store Layout-with-Clusters user interface 128. In user interface 1500, a layout 1502 of departments in a store is provided. In the embodiment of FIG. 15, departments are referred to generically by letters, however, those skilled in the art will recognize that the letters can be replaced with department names such as Women's, Men's, Children's, Health and Beauty, Hardware, Household Goods, Electronics and Grocery, for example. In user interface 1500, departments that are clustered together in step 1406 are shown with a same coloring, depicted by the hatching in FIG. 15. Thus, department J and department D are in the same cluster, department I and department E are in the same cluster and department B and department H are in the same cluster. Departments A, G and F are not clustered with other departments, and as such are not colored. Thus, in FIG. 15, the online actions indicate that when online users view products in department I, they also view products in department E. Similarly, when users view products in department J online, they also view products in department D online and when users view products in department B, they also view products in department H.

User interface 1500 indicates to store layout manager 132 that the current store layout is inefficient for many customers because products that online customers have indicated they like to view together during a single shopping experience are spread across the store layout. In response, store layout manager 132 produces modified or altered store layout 1602 shown in user interface 1600 of FIG. 16. Modified store layout 1602 creates a more efficient customer experience since department E and department I are now next to each other making it easier for a shopper to view products in both department I and department E while shopping. Similarly, department D and department J have been moved next to each other and department B and department H are positioned near each other. Thus, by modifying the layout of the physical store, store layout manager 132 has made the shopping experience more convenient for the customer by placing products that online customers viewed during a same session closer together in a physical store.

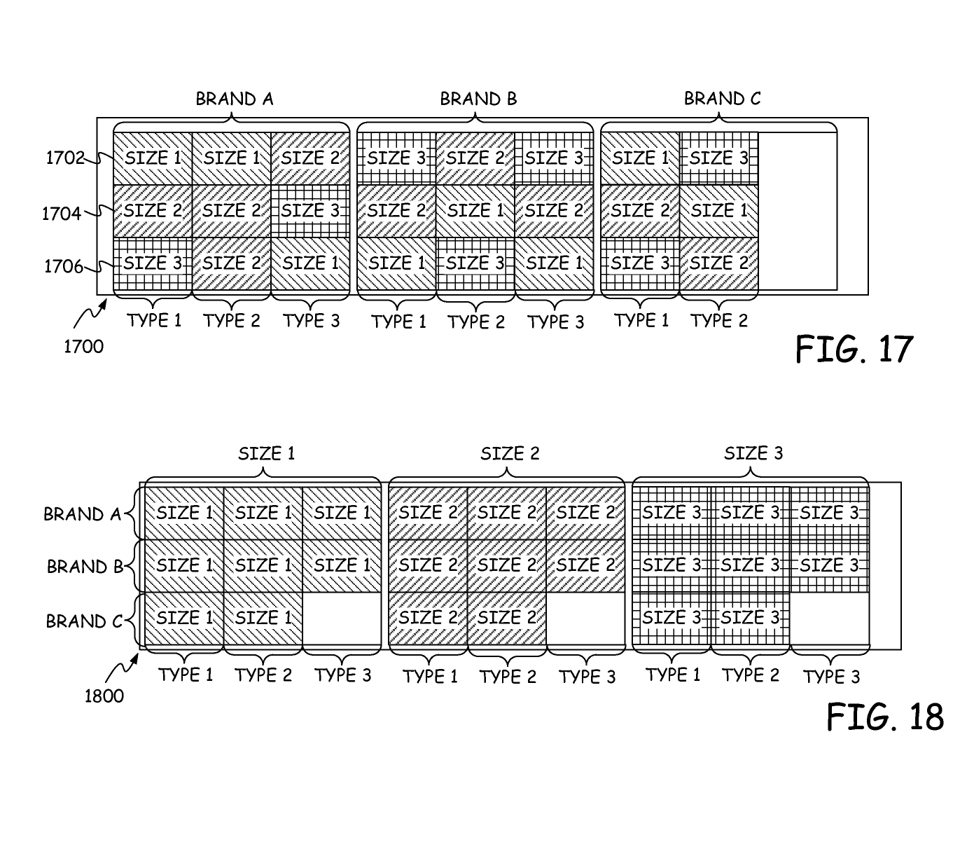

FIG. 17 provides a user interface 1700 that depicts a product layout for a department such as an electronics department. User interface 1700 is a second embodiment of a store layout with user interface 128 that is produced at step 1410 of FIG. 14. In user interface 1700, products in a same cluster are shaded a same color as indicated by the hatching. In user interface 1700 of FIG. 17, there are three clusters: 1702, 1704 and 1706. Cluster 1702 is associated with a first size range, cluster 1704 is associated with a second size range and cluster 1706 is associated with a third size range. In the existing store layout of user interface 1700, the products are grouped based on brand such that all the products of brand A are together, all the products of brand B are together and all the products of brand C are together. Within each brand grouping, the products are further grouped by the type of product with all of the type 1 products in one column, all the of the type 2 products in a second column and all of the type 3 products in a third column.

As indicated by user interface 1700, online customers do not view these products primarily on brand but instead view the products based on size first. Based on this information, store layout manager 132 produces a modified store layout 1800 as shown in FIG. 18. In modified store layout 1800, all of the size 1 products are grouped together, all of the size 2 products are grouped together and all of the size 3 products are grouped together. This grouping is more efficient for the consumers since online consumers have shown that they are more likely to view products in the same size category when shopping for this class product instead of viewing all of the products provided by a particular brand. As shown in FIG. 18, within a store area set aside for a size cluster, the products can be organized by brand and/or type of product.

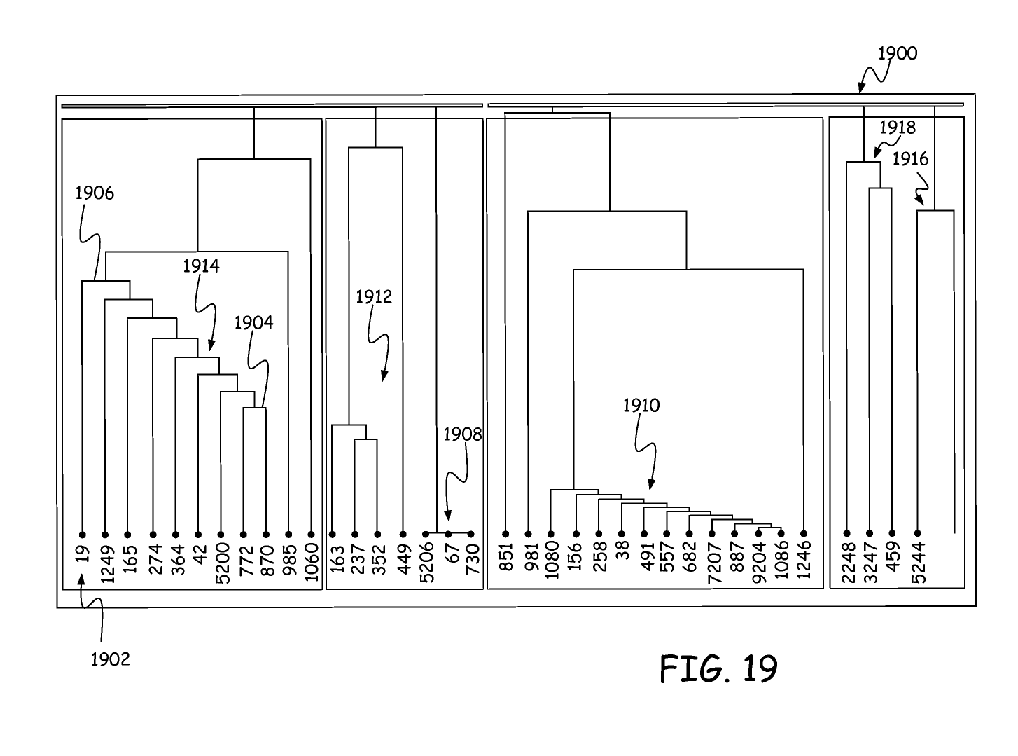

FIG. 19 provides a user interface 1900 that can be generated by visualization application 122 to provide an additional view of the affinity between departments within a store. In FIG. 19, a Dendrogram is provided which shows the affinity between departments within a retail store. This affinity is based on the co-occurrence of products viewed online from the various departments. In FIG. 19, the departments are identified by department identifiers along a bottom row 1902. Departments are connected based on their affinity to other departments. The height of the horizontal segment that connects two departments or that connects a department to a collection of departments, such as horizontal segment 1904, indicates the affinity between the two departments or between the department and the collection of departments. Thus, the departments connected by horizontal line 1904 have a greater affinity than the departments connected by horizontal line 1906. In FIG. 19, six clusters of departments are shown including cluster 1908, 1910, 1912, 1914, 1916 and 1918.

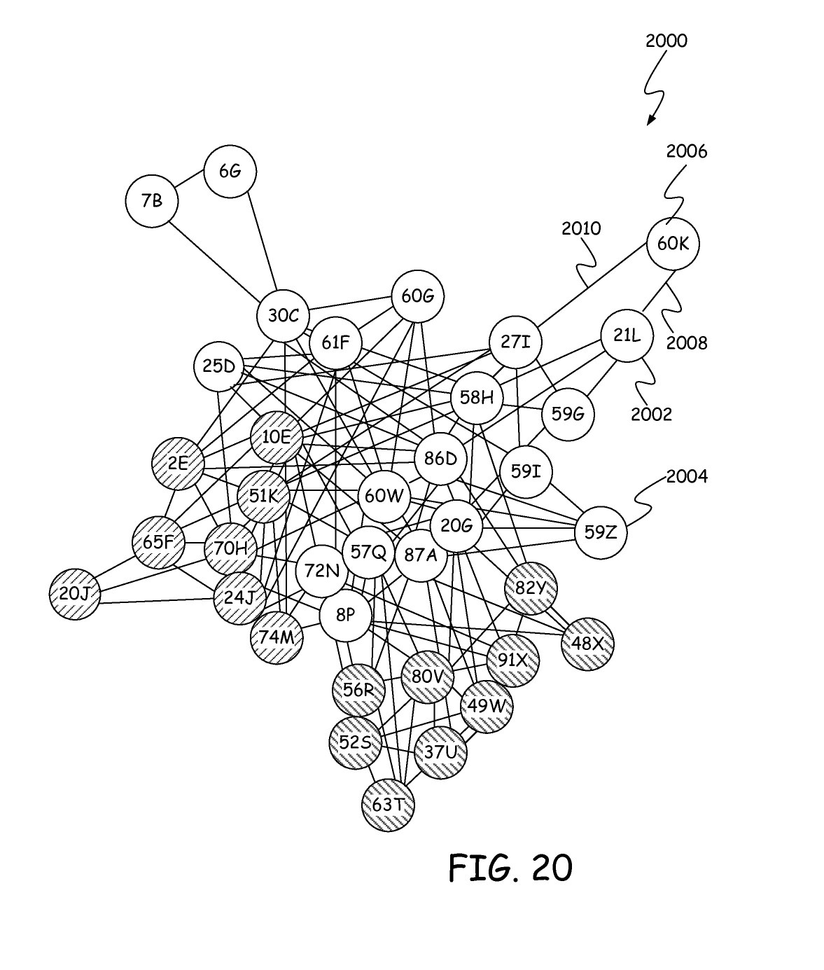

FIG. 20 provides a user interface 2000 that can be generated by visualization application 122 to provide an additional view of the affinity between departments within a store. In user interface 2000, each department is represented by a circle, such as circles 2002, 2004 and 2006, with all the circles having a same size. Each of the circles is connected by a line such as lines 2008 and 2010, to those departments for which there is at least one co-occurrence count in the online session histories. The length of the lines between any two departments is inversely related to the affinity between the departments such that longer lines indicate a lower affinity and shorter lines indicate greater affinity. In user interface 2000, clusters of departments are indicated by shading in the circles as indicated by the different hatching depicted in the circles.

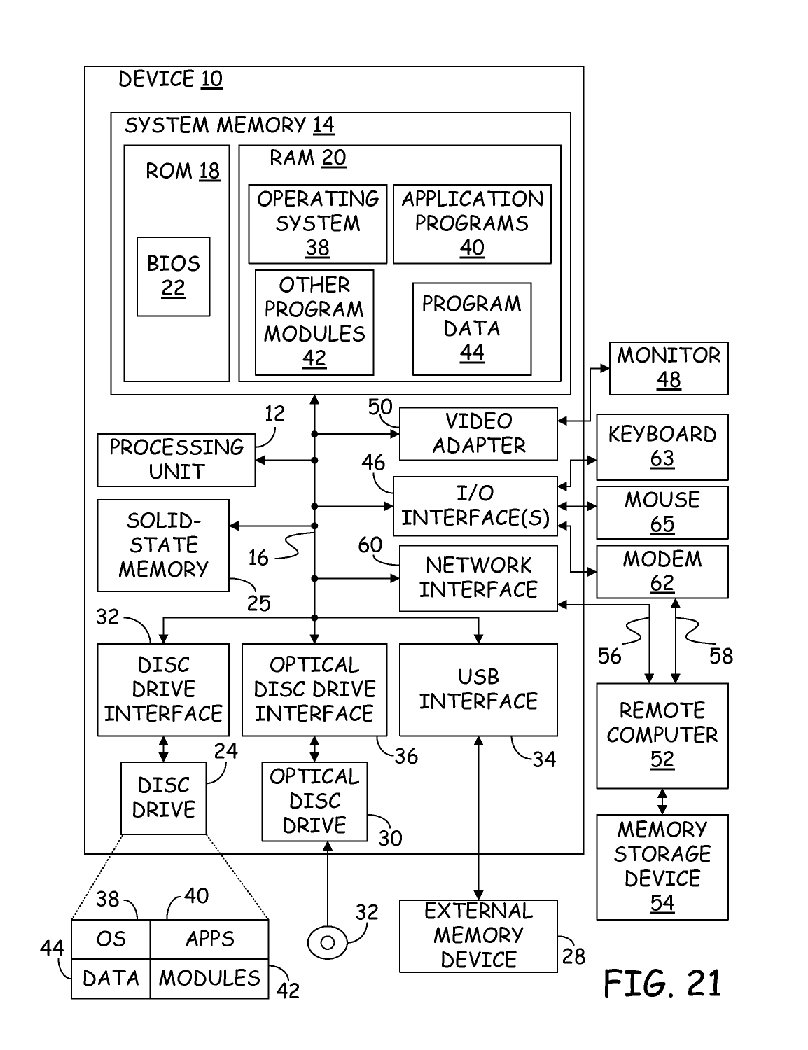

FIG. 21 provides an example of a computing device 10 that can be used as a client device, server device, data processing device or data warehouse device in the embodiments above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing site instructions 106, data munging unit 116, clustering application 120, and visualization application 122, for example. Program data 44 may include data such as session histories 112, session histories 114, product information 108, and search parameters 118, for example.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 21. The network connections depicted in FIG. 21 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 21 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A method comprising:
identifying clusters of products based on user interactions with product information stored on a computer network; and
displaying a layout of a physical store such that for at least one cluster of products, the displayed layout indicates which areas of the physical store contain products in the cluster.

2. The method of claim 1 wherein displaying a layout comprises displaying areas that contain products in a same cluster with a same color.

3. The method of claim 1 further comprising:
receiving a modified layout of the physical store, wherein the modified layout has been created based on the displayed layout; and
displaying the modified layout such that for at least one cluster, the displayed modified layout indicates which areas of the physical store contain products in the cluster.

4. The method of claim 1 wherein identifying clusters of products based on user interactions with product information comprises identifying clusters of products based on user views of product information regardless of whether products are purchased.

5. The method of claim 1 wherein identifying clusters of products based on user interactions with product information comprises identifying clusters of products based on multiple user interactions over multiple different sessions.

6. The method of claim 5 wherein identifying clusters comprises:
defining product groups;
collecting a co-occurrence count for each pair of product groups where the co-occurrence count for a pair of product groups is the number of sessions where users viewed information about products from both of the pair of product groups during the session; and
identifying clusters of product groups from the co-occurrence counts.

7. The method of claim 6 wherein each product group comprises a store department and wherein for at least one cluster of store departments, the displayed layout indicates which areas of the physical store contain store departments in the cluster of store departments.

8. The method of claim 6 wherein displaying the store layout comprises mapping each product group in a cluster to at least one store area on the store layout.

9. A method comprising:
forming affinity groups for products based on online actions;
retrieving attributes of the products;
displaying the affinity groups and the attributes for each product;
identifying a common attribute of products within an affinity group; and
altering a layout of a physical store based on the common attribute.

10. The method of claim 9 wherein forming affinity groups for products comprises forming affinity groups of products that are found in a physical store department.

11. The method of claim 9 wherein altering the layout of a physical store comprises moving products with the common attribute closer together.

12. The method of claim 9 further comprising forming second affinity groups of products within an affinity group, identifying a common attribute of products within each second affinity group and altering the layout of the physical store based on the common attribute in each second affinity group.

13. The method of claim 9 wherein forming affinity groups comprises forming groups of products that share at least one attribute and determining affinities between products in each group of products.

14. The method of claim 9 wherein the online actions comprise viewing products online during a same session regardless of whether a product was purchased.

15. A system comprising:
site instructions that provide user interfaces that display products for sale and that store records of products displayed during each of a plurality of online sessions;
a clustering application that uses the records of products displayed to form clusters of products; and
a visualization application that displays the physical location of the clusters on a layout for a physical store.

16. The system of claim 15 wherein the clustering application forms clusters of different product groups based on the records of products displayed.

17. The system of claim 16 wherein the clustering application uses co-occurrence data of the product groups to form the clusters.

18. The system of claim 15 wherein the visualization application maps each product group to a store area and colors each product group's store area based on the cluster that the product group is assigned to by the clustering application.

19. The system of claim 15 wherein the visualization application displays the physical locations of the clusters on a revised layout for a physical store.

20. The system of claim 15 wherein the clustering application uses an affinity threshold when forming clusters of products.
